(19) United States
(12) Patent Application Publication
(10) Pub. No.: US 2007/0026303 A1
(43) Pub. Date: Feb. 1, 2007

(54) Battery module

(76) Inventors: Yoon-Cheol Jeon, Suwon-si (KR); Tae-Yong Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/494,243

(22) Filed: Jul. 27, 2006

(30) Foreign Application Priority Data
Jul. 29, 2005 (KR) 10-2005-0069444

(51) Int. Cl. H01M 2/18; H01M 10/50; H01M 10/04

(52) U.S. Cl. 429/143; 429/152; 429/120; 429/50; 29/623.1

(57) ABSTRACT

A battery module including unit cells and a cell barrier interposed between the unit cells is disclosed. The cell barrier includes a plate and protrusions formed on one or both sides of the plate. The cell barrier supports the unit cells and provides coolant passages through which a coolant can flow and contact the unit cells.

### CROSS-REFERENCE TO RELATED APPLICATION

This application claims priority to Korean patent application No. 10-2005-0069444 filed in the Korean Intellectual Property Office on Jul. 29, 2005, and all the benefits accruing therefrom under 35 U.S.C. §119. The contents of the Korean patent application are incorporated herein by reference in their entirety.

### BACKGROUND OF THE INVENTION

1. Field of the Invention

The present invention relates to a battery module. More particularly, the present invention relates to a cell barrier of a battery module.

2. Description of the Related Art

A rechargeable or secondary battery is generally distinguished from a primary battery in that it can be repeatedly charged and when discharged. A rechargeable battery with low capacity is used as a power source for various small electronic devices such as mobile phones, laptop computers, and camcorders. On the other hand, a rechargeable battery with high capacity can be used as a power source for driving a motor of a hybrid electric automobile and the like. Typically, rechargeable batteries with low capacity are connected in series to form a high capacity rechargeable battery module.

The rechargeable battery module generally includes a plurality of rechargeable battery units, which are often referred to as unit cells (hereinafter “unit cells”). The unit cells respectively include an electrode assembly, which is composed of positive and negative electrodes and a separator interposed therebetween, a case having a space for housing the electrode assembly, and a cap assembly combined with the case and sealing it.

The unit cells generate heat during electrochemical reactions occurring therein. For high performance, heat generated from the unit cells should be quickly and efficiently removed to avoid malfunctioning of the batteries. It is particularly so in batteries comprised of a number of unit cells and designed for high capacity. To remove heat or cool the unit cells, a battery module commonly includes a cell barrier interposed between and separating two adjacent unit cells.

The above information in this background section is only for the understanding of the background of the invention, and no statement in this section constitutes an admission of prior art.

### SUMMARY OF CERTAIN INVENTIVE ASPECTS

One aspect of the invention provides a battery module. The battery module comprises: a plurality of unit cells comprising a first unit cell and a second unit cell; and a cell barrier interposed between the first and second unit cells, wherein the cell barrier comprising a plate, which comprises a first surface facing the first unit cell and a second surface facing the second unit cell, wherein the cell barrier may further comprise a plurality of protrusions protruding from the first surface, wherein at least part of the protrusions contact the first unit cell such that the plate is separated from the first unit cell with a gap therebetween and that a fluid passage is formed between the plate and the first unit cell through the gap, at least one protrusion protruding from the second surface, wherein the at least one protrusion contact the second unit cell such that the plate is separated from the second unit cell with a gap therebetween and that a fluid passage is formed between the plate and the second unit cell through the gap therebetween.

In the above-described battery module, the first unit cell may comprise a case housing an electrode assembly, and the at least part of the protrusions may contact the case of the first unit cell. All or substantially all of the plurality of protrusions may contact the first unit cell. The cell barrier may comprise substantially the same features on the second surface as those on the first surface. The fluid passage may be defined by the gap and the plurality of protrusions. The battery module may further comprise a plurality of additional cell barriers, each of which may be interposed between two adjacent ones of the plurality of unit cells. Each of the additional cell barriers may comprise a plate and a plurality of protrusions protruding from the plate, wherein at least part of the protrusions may contact one of the adjacent unit cells so as to form a gap between the plate and the adjacent unit cell and to form a fluid passage therebetween.

Still in the battery module, the plurality of protrusions may be substantially regularly arranged on the first surface. At least part of the plurality of protrusions may be arranged to form two or more rows on the first surface, and protrusions of two immediately adjacent rows may be alternatingly arranged along the rows. The plurality of protrusions may have generally the same shape. The plurality of protrusions may comprise two or more differently shaped protrusions. At least part of the plurality of protrusions may have a cross-sectional shape taken in an imaginary plane substantially parallel to the first surface, and the cross-sectional shape may be generally one or more selected from the group consisting of circles, ovals, polygons and polygons with at least one rounded corner. At least part of the plurality of protrusions may have a general shape selected from the group consisting of columns, cylinders truncated cones, truncated pyramids and hexahedrons. The plurality of protrusions may be integrally formed with the plate. At least one of the first and second unit cells may have a generally prismatic shape. The first unit cell, the second unit cell and the cell barrier may be bound together.

Another aspect of the invention provides a method of cooling a battery module. The method comprises: providing the above-described battery module; and supplying a coolant to around the battery module such that at least part of the coolant passes through the fluid passage, thereby cooling the battery module. The first unit cell may comprise a case housing an electrode assembly, and the at least part of the coolant may contact the case of the first unit cell while passing through the fluid passage.

Still another aspect of the invention provides a method of making a battery module. The method comprises: providing a first unit cell, a second unit cell and a cell barrier comprising a plate with a first surface and a second surface, the cell barrier further comprising a plurality of protrusions protruding from the first surface and at least one protrusion protruding from the second surface; interposing the cell barrier between the first and second unit cells such that the first surface faces the first unit cell and that at least part of the protrusions contact the first unit cell such that the plate is separated from the first unit cell with a gap therebetween and that a fluid passage is formed between the plate and the first unit cell through the gap, and the second surface faces the second unit cell and that at least one protrusion contacts the second unit cell such that the plate is separated from the second unit cell with a gap therebetween and a fluid passage is formed between the plate and the second unit cell through the gap therebetween; and binding the first unit cell, the second unit cell and the cell barrier together.

Another aspect of the present invention provides a battery module that includes a cell barrier that has strength enough to maintain a unit cell shape and is efficiently capable of controlling a temperature of a unit cell. According to one embodiment of the present invention, a battery module includes unit cells and a cell barrier disposed between the unit cells and having protrusions for supporting the unit cells and securing passages through which a coolant can flow around the unit cells, respectively.

The cell barrier may include a plate, and the protrusions may be disposed on the plate in a predetermined pattern. The protrusions may be disposed to face each other on the plate. The protrusions may be formed as a circular truncated cone. The protrusions may be formed as a cylinder. The protrusion may be formed as a hexahedron. The protrusion may be formed as a hexagonal prism. The protrusions may be disposed in a row or column on the plate. The protrusions in an adjacent row or column may be disposed in the same line. The protrusions in an adjacent row or column may be alternatively disposed. The unit cell may be prismatic.

### BRIEF DESCRIPTION OF THE DRAWINGS

The above and other features and advantages of the present invention will become more apparent in the following description of embodiments with reference to the attached drawings in which:

FIG. 1 is a schematic cross sectional view of a battery module according to one embodiment of the present invention;

FIG. 2 is a schematic perspective view of a battery module according to one embodiment of the present invention;

FIG. 3 is a schematic perspective view of a cell barrier according to one embodiment of the present invention;

FIG. 4 is a cross sectional view along a IV-IV line in FIG. 3;

FIGS. 5A, 5B, 6A and 6B are perspective views of cell barriers according to embodiments of the present invention; and

FIG. 7 is a cross sectional view of a cell barrier according to another embodiment of the present invention.

### DETAILED DESCRIPTION OF CERTAIN INVENTIVE EMBODIMENTS

Various features of the present invention will now be described more fully hereinafter with reference to the accompanying drawings. The concepts, principles and features of the invention, however, are not limited to the embodiments set forth herein. Rather, these embodiments are provided so that this disclosure will be thorough and complete, and will fully convey the scope of the invention to those skilled in the art. In the drawings, the dimensions of features may be exaggerated for the purpose of illustration and do not represent that illustrated features should have such dimensions. Further in the drawings, like reference numerals refer to like elements throughout.

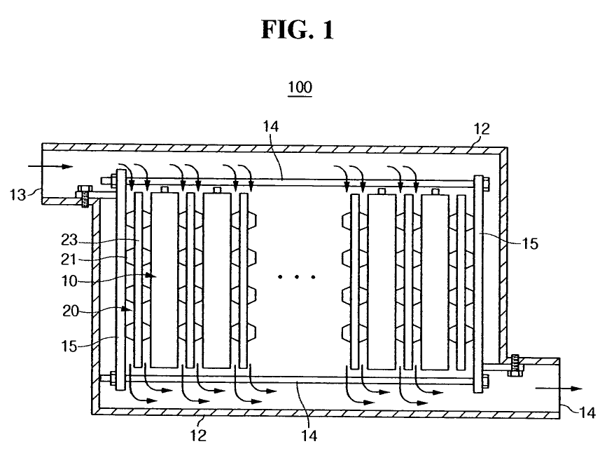

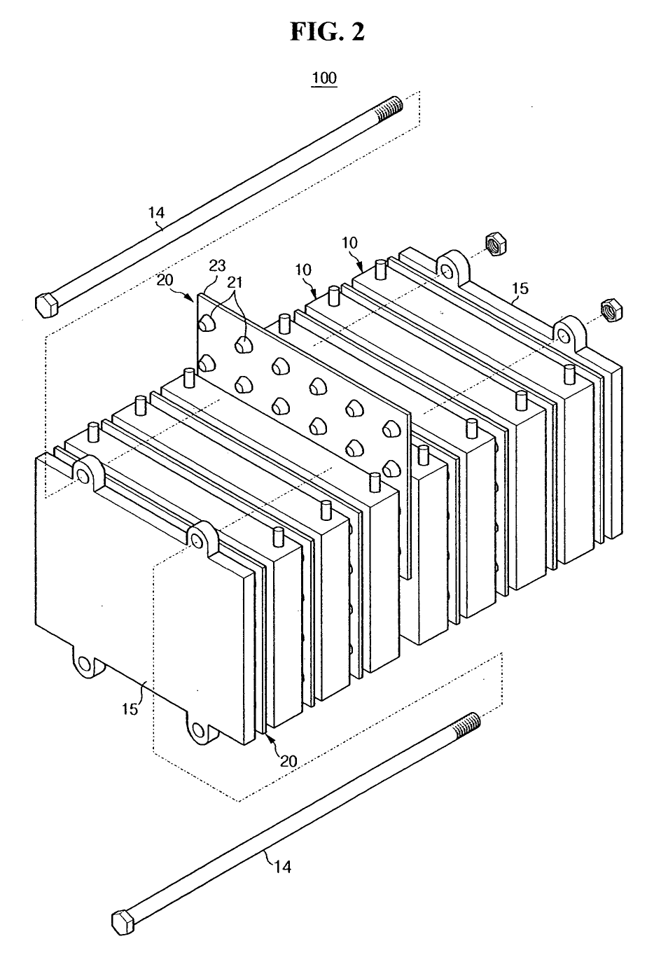

FIG. 1 is a schematic cross sectional side view showing the structure of a battery module. FIG. 2 shows a perspective view of an assembly including unit cells and end plates of a battery module. Referring to these drawings, a battery module 100 includes a plurality of unit cells 10 and a plurality of cell barriers 20, each of which is placed between two adjacent unit cells 10. As illustrated, the unit cells 10 and cell barriers 20 are stacked together. The cell barriers 20 keep the two adjacent unit cells separated from each other with a distance therebetween. Further, the cell barrier 20 provides a coolant or fluid passage, through which a coolant or fluid can circulate. The battery module 100 further includes end plates 15 disposed at the outermost sides of the stack of the unit cells 10. The end plates 15 bind the stacked unit cells and cell barriers to form a single modular body with a retaining rod 14. In other embodiments, other forms of binding mechanism may be used to bind the staked pieces into one body.

According to embodiments of the present invention, the unit cells may have various shapes and configurations as long as they can be stacked. In one embodiment, the unit cells are in a prismatic shape, which includes an electrode assembly contained in a case. The electrode assembly includes a positive electrode, a negative electrode and a separator electrically separating the electrodes. The unit cell may further include a cap liquid or air-tightly closing the case.

Referring to FIG. 1, the battery module 100 further includes a housing 12, which has an inlet 13 and an outlet 14 for flowing a coolant in and out. In embodiments, the coolant can be any fluid that can pass through the battery housing and passage. The fluid can be liquid or gas. In some embodiments, the coolant is in gaseous phase. In some embodiments, the coolant is air.

In the illustrated embodiment, the coolant inlet 13 is formed near one end plate 15 (left) on one side (top) of the stacked unit cells and cell barriers. The coolant outlet 14 is formed near the other end plate 15 (right) on the opposing side (bottom) of the stacked unit cells and cell barriers. Further, the housing 12 of the battery module 100 includes a space over the staked unit cells and cell barriers. The space is connected to the inlet 13 and allows the coolant flowing into the housing 12 to move and reach unit cells and cell barriers located further from the inlet 13. Also, the housing 12 includes a space under the stacked unit cells and cell barriers. The space is connected to the outlet 14. As illustrated, the coolant is flowing into the housing 12 through the inlet 12 and passes through the stacked unit cells and cell barriers and flow out of the housing 12 through the outlet 14. In embodiments, the housing, inlet, outlet and spaces within the housing can be implemented in a number of different ways and configurations and are not limited to what is disclosed in the drawings.

As noted above, the coolant flowing into the housing 12 passes through the stacked unit cells and cell barriers via passages or channels formed therein. In embodiments, the passages or channels are formed or defined by the neighboring pairs of a unit cell and a cell barrier, as will be described in more detail below. The coolant passing through the passages or channels contact the case of the unit cells and take heat from the unit cells.

According to the present embodiment, the cell barrier 20 includes a plate 23 and a plurality of protrusions 21 disposed on both sides of the plate 23. In the illustrated embodiment, the plurality of protrusions 21 is generally regularly distributed on the plate 23. In other embodiments the plurality of protrusions 21 are generally randomly distributed. In some embodiments, the plurality of protrusions 21 are formed only one side of the plate 23 rather than both.

In some embodiments, the total thickness of the cell barrier 20 in the direction perpendicular to the plate 23 is substantially equal to the thickness of individual unit cell 10. In embodiments where the protrusions 21 are formed on both side, the total thickness is comprised of the thicknesses of the plate 23, a protrusion one side of the plate and another protrusion on the other side of the plate. In embodiments where the protrusions 21 are formed only one side, the total thickness is comprises of the thicknesses of the plate and one protrusion.

In some embodiments, the protrusions 21 have substantially the same thickness in the direction perpendicular to the plate such that when the cell barrier 20 is disposed between two unit cells 10, the protrusions 21 can contact the unit cell(s) 10 and. In this construction, all or substantially all of the protrusions 21 contribute to support the unit cell they contact and maintain the distance between the plate 23 and that unit cell. In other embodiments, not all the protrusions 21 have the same thickness in the direction perpendicular to the plate. In this construction, only part of the protrusions 21 contact the unit cell next to the cell barrier 20. In these embodiments, the space formed between the protrusions 21 and further between the plate 23 and the neighboring unit cell functions as a passage through which the coolant can circulate. The cell barrier 20 has excellent cooling efficiency as the coolant circulating the space can directly contact the unit cell next thereto and take heat away from the unit cell 10. Further in the embodiments where the cell barrier 20 has protrusions 21 on both sides of the plate 23, two coolant passages are formed by a single cell barrier, which even facilitates the passage of the coolant from one side of the stacked battery to the other side, thereby efficiently cooling unit cells 10. In addition, the coolant passage or the space is formed throughout the plate 23, the coolant circulating space can reach any place on the plate 23 except where the protrusions 21 are formed and also can reach any place on the surface of the unit cell that faces the plate except where the protrusions 21 contact. Thus, cooling of the unit cells 10 can be substantially uniform on the surface of the unit cell 10 in contact with the protrusions 21.

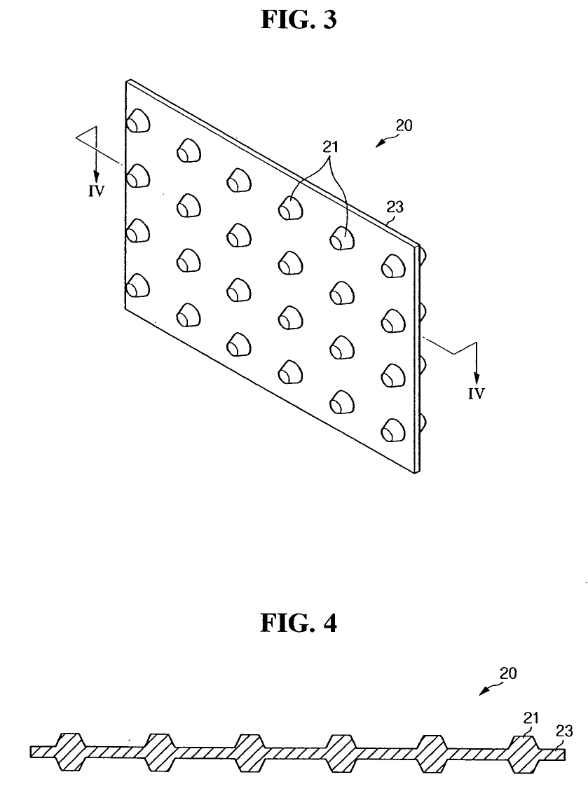

FIG. 3 shows a perspective view of a cell barrier 20 according to one embodiment of the present invention, and FIG. 4 shows a cross sectional view cut along a IV-IV line of the cell barrier 20 of FIG. 3. According to the illustrated embodiment, the cell barrier 20 includes a plate 23 and a plurality of protrusions 21 formed on both sides of the plate 23. The protrusions 21 are generally of a truncated cone with the wider portion of the cone contact the plate 23. According to the illustrated embodiments, the protrusions 21 are disposed generally regularly and form a plurality of rows and columns with a predetermined interval.

Since the truncated cone-shaped protrusions 21 gradually become smaller toward away from the plate 23, more space for coolant circulation can be secured. Also, since the protrusions 21 have a curved surface, the coolant can smoothly flow within the spaces without substantial obstruction of such flow.

According to FIG. 4, two protrusions 21 on both sides of the plate 23 are at the same position on the plate 23. In embodiments that are not illustrated, the position of protrusions 21 of the two sides of the plate 23 may not be correlated throughout or at all. In other embodiments, although not illustrated, protrusions with the truncated cone shape are formed only one side of the plate 23. In one embodiment, the protrusions 21 are integrally formed substantially simultaneously with the plate 23. In another embodiment, separately formed protrusions 21 may be fixed onto the plate 23.

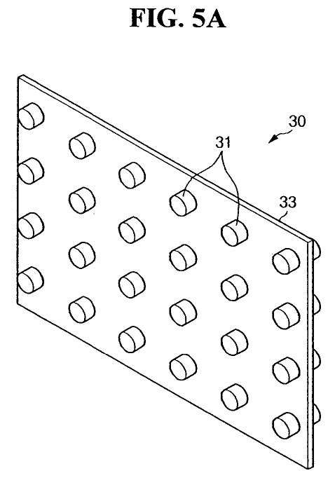

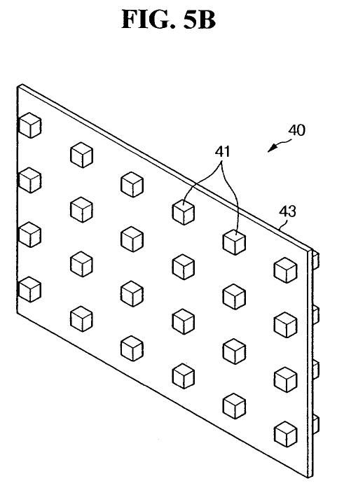

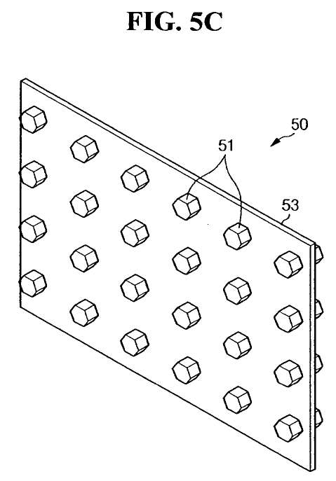

FIG. 5A is a perspective view of a cell barrier according to another embodiment of the present invention. As shown in FIG. 5A, the cell barrier 30 includes a plate 33 and a plurality of protrusions 31 disposed on both sides of the plate 33. The cell barrier 30 has the same basic structure and operation as the embodiment shown in FIG. 3 except that the protrusions 31 are columnal or cylindrical rather than truncated cone.

FIG. 5B is a perspective view of a cell barrier according to another embodiment of the present invention. As shown in FIG. 5B, the cell barrier 40 also includes a plate 43 and a plurality of protrusions 41 disposed on both sides of the plate 43. The cell barrier 40 has the same basic structure and operation as the previous embodiments except that the protrusions are rectangular parallelepiped or cubical. In this embodiment, the coolant can experience some turbulence around protrusions 41 when it flows along the spaces between the protrusions 41. Such turbulence may facilitate the coolant to disperse within the space and also can hold the coolant to stay longer within the space formed by the cell barrier 40, which can improve cooling effects on unit cells.

FIG. 5C is a perspective view of a cell barrier 50 according to another embodiment of the present invention. As shown in FIG. 5C, the cell barrier 50 includes a plate 53 and protrusions 51 formed on each side of the plate 53. The cell barrier 50 has the same basic structure and operation as the foregoing embodiments except that the protrusions 51 are in hexagonal columns. Compared with the cell barrier of FIG. 5B, this cell barrier 51 has similar turbulence of the coolant but may have a little lower pressure of the coolant flow within the space formed by the cell barrier 50.

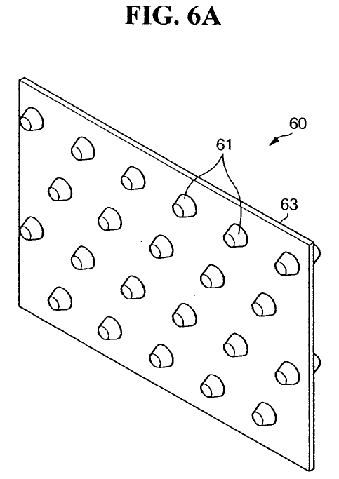

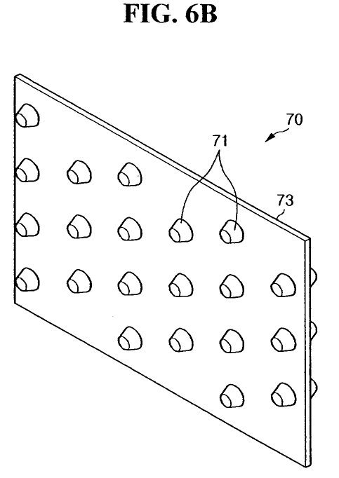

FIGS. 6A and 6B show perspective views of cell barriers 60 and 70 according to still other embodiments of the present invention. The cell barriers 60 and 70 include a plate 63 and 73 and a plurality of protrusions 61 and 71 disposed on both sides of each plate 63 and 73. The protrusions 61 and 71 in these embodiments are truncated cone shapes as those shown in FIG. 3. In FIG. 6A, the protrusions 61 are arranged such that every protrusion participates in forming rows parallel to the top edge of the plate 63. Also, the protrusions 61 in every other row form a column parallel to the side edges of the plate 63. Further, the protrusions 61 form linear arrangements along imaginary lines slanted with reference to the top edge of the plate 63.

In FIG. 6B, every protrusion 71 participates to form columns parallel to the side edges of the plate 73. The protrusions in every other column form a row parallel to the top edge of the plate 73. Also, the protrusions 71 in every other row form a column parallel to the side edges of the plate 63. Further, the protrusions 71 form linear arrangements along imaginary lines slanted with reference to the top edge of the plate 73.

The cell barriers 60 and 70 may improve efficiency of cooling unit cells as they increase the diffusion rate of a coolant within the space formed by these cell barriers by letting the coolant to hit the protrusions often while passing therethrough. Further, the cell barriers 60 and 70 may have effects on appropriately supporting the unit cell without being inclined to one side.

In some embodiments, the cell barriers may allow the coolant to flow in certain directions. In some embodiment, the cell barriers have an inlet and an outlet for the coolant to flow in and out therethrough. In one embodiment, the cell barrier is designed to flow the coolant in a direction generally parallel to the longer edge of the plate. This configuration is advantageous because the coolant can stay longer within the space formed by the cell barriers.

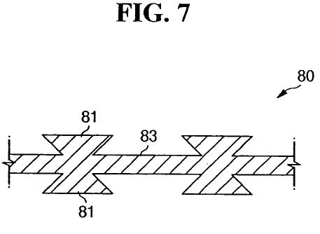

FIG. 7 shows a cross sectional view of a cell barrier according to another embodiment of the present invention. The cell barrier 80 includes a plate 83 and protrusions 81 on both sides of the plate 83 as in other embodiments except that the protrusions 81 are gradually wider in a direction perpendicular to and away from the plate 83.

According to embodiments of the present invention, a battery module includes a plurality of unit cells, each of which is separated from its neighboring unit cell by a cell barrier. The cell barrier of embodiments includes a plate and a plurality of protrusions on one or both sides of the plate. The protrusions from one side of the plate contact a wall of one of the immediately neighboring unit cells. One or two coolant passages are formed by one cell barrier between the wall and the plate and further between the protrusions. A coolant is supplied to the battery module and passes through the coolant passages, thereby cooling the unit cells by contacting the wall while passing through the passages. Various protrusions are disclosed by way of embodiments. However, the shapes, configurations, size, number and arrangements of these protrusions are not limited to those disclosed above.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A battery module comprising:
a plurality of unit cells comprising a first unit cell and a second unit cell; and
a cell barrier interposed between the first and second unit cells, wherein the cell barrier comprises a plate that comprises:
a first surface facing the first unit cell;
a second surface facing the second unit cell;
a plurality of protrusions protruding from the first surface, wherein at least part of the protrusions contact the first unit cell such that the plate is separated from the first unit cell with a gap therebetween and a fluid passage is formed between the plate and the first unit cell through the gap; and
at least one protrusion protruding from the second surface, wherein the at least one protrusion contacts the second unit cell such that the plate is separated from the second unit cell with a gap therebetween and a fluid passage is formed between the plate and the second unit cell through the gap therebetween.

2. The battery module of claim 1, wherein the first unit cell comprises a case housing an electrode assembly, and wherein the at least part of the protrusions contacts the case of the first unit cell.

3. The battery module of claim 1, wherein all or substantially all of the plurality of protrusions contact the first unit cell.

4. The battery module of claim 1, wherein the cell barrier comprises substantially the same features on the second surface as those on the first surface.

5. The battery module of claim 1, wherein the fluid passage is defined by the gap and the plurality of protrusions.

6. The battery module of claim 1, further comprising a plurality of additional cell barriers, each of which is interposed between two adjacent ones of the plurality of unit cells.

7. The battery module of claim 6, wherein each of the additional cell barriers comprises a plate and a plurality of protrusions protruding from the plate, wherein at least part of the protrusions contact one of the adjacent unit cells so as to form a gap between the plate and the adjacent unit cell and to form a fluid passage therebetween.

8. The battery module of claim 1, wherein the plurality of protrusions are substantially regularly arranged on the first surface.

9. The battery module of claim 1, wherein at least part of the plurality of protrusions are arranged to form two or more rows on the first surface, and wherein protrusions of two immediately adjacent rows are alternatingly arranged along the rows.

10. The battery module of claim 1, wherein the plurality of protrusions have generally the same shape.

11. The battery module of claim 1, wherein the plurality of protrusions comprises two or more differently shaped protrusions.

12. The battery module of claim 1, wherein at least part of the plurality of protrusions have a cross-sectional shape taken in an imaginary plane substantially parallel to the first surface, and wherein the cross-sectional shape is generally one or more selected from the group consisting of circles, ovals, polygons and polygons with at least one rounded corner.

13. The battery module of claim 1, wherein at least part of the plurality of protrusions have a general shape selected from the group consisting of columns, cylinders truncated cones, truncated pyramids and hexahedrons.

14. The battery module of claim 1, wherein the plurality of protrusions are integrally formed with the plate.

15. The battery module of claim 1, wherein at least one of the first and second unit cells has a generally prismatic shape.

16. The battery module of claim 1, wherein the first unit cell, the second unit cell and the cell barrier are bound together.

17. A method of cooling a battery module, the method comprising:
providing the battery module of claim 1; and
supplying a coolant to around the battery module such that at least part of the coolant passes through the fluid passage, thereby cooling the battery module.

18. The method of claim 17, wherein the first unit cell comprises a case housing an electrode assembly, and wherein the at least part of the coolant contacts the case of the first unit cell while passing through the fluid passage.

19. A method of making a battery module, the method comprising:
providing a first unit cell, a second unit cell and a cell barrier comprising a plate with a first surface and a second surface, the cell barrier further comprising a plurality of protrusions protruding from the first surface and at least one protrusion protruding from the second surface;
interposing the cell barrier between the first and second unit cells such that the first surface faces the first unit cell and that at least part of the protrusions contact the first unit cell such that the plate is separated from the first unit cell with a gap therebetween and a fluid passage is formed between the plate and the first unit cell through the gap, and the second surface faces the second unit cell and that at least one protrusion contacts the second unit cell such that the plate is separated from the second unit cell with a gap therebetween and a fluid passage is formed between the plate and the second unit cell through the gap therebetween ; and
binding the first unit cell, the second unit cell and the cell barrier together.
